(19) United States
(12) Patent Application Publication
(10) Pub. No.: US 2004/0202362 A1
(43) Pub. Date: Oct. 14, 2004

(54) Wafer carrying robot teaching method and teaching plate

(76) Inventors: Shinichi Ishikawa, Fukuoka (JP); Hitoshi Wakizako, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/474,820

(22) PCT Filed: Apr. 11, 2002
(86) PCT No.: PCT/JP02/03644

(30) Foreign Application Priority Data
Apr. 13, 2001 (JP) P. 2001-115453

(51) Int. Cl. G06K 9/00

(52) U.S. Cl. 382/153

(57) ABSTRACT

A method for teaching a water carrying robot which employs a simple, inexpensive apparatus and is capable of not only maintaining a clean condition inside a front end but also effecting a saving of teaching work.

A positioning mark (3) is provided on the hand (2) of a wafer carrying robot (1) and a teaching plate (5) having a camera (6) for pickup of the positioning mark (3) is arranged at a predetermined position. The positioning mark (3) is photographed by the camera (6) and an operator corrects the position of the hand (2) so that the positioning mark (3) occupies a predetermined position in an image of the camera (6) and positions the hand (2) in a horizontal plane.

### BACKGROUND OF THE INVENTION

1. Technical Field

The present invention relates to a method for teaching, a wafer carrying robot and particularly a wafer carrying robot for carrying wafers held in a wafer cassette out of the wafer cassette and to a teaching plate for use in this method.

2. Background Art

As wafers are required to be always placed in a highly clean environment during the process of manufacturing semiconductors, wafers are carried to each processing unit while housed in an airtight wafer cassette called FOUP (Front Opening Unified Pod) and SMIF (Standard Mechanical Interface Pod). Moreover, each wafer is delivered from a wafer cassette to a processing unit through a section called a front end which is environmentally cleaner than the outside of the front end.

FIG. 10 is a conceptual illustration of a front end. In FIG. 10, reference numeral 1 denotes a wafer carrying robot arranged within a front end 20. The front end 20 is a kind of air lock attached to a processing unit 21 and is a section for letting the processing unit 21 communicate with the outside. Wafers 22 are housed in a wafer cassette 4 and carried to the front side of the front end 20. A gate (not shown) is installed between the wafer cassette 4 and the front end 20 and opened so that the wafer 22 inside the wafer cassette 4 is picked up by the wafer carrying robot 1 and carried into the processing unit 21.

Incidentally, in the work of teaching a teaching playback type robot, it is common for an operator to give teaching while visually inspecting the motion near the robot. However, the operator is hardly able to go in and out of a front end unit because the front end unit is narrow in width and the necessity of not allowing any person into the front end as much as possible so as to maintain a clean condition inside results in making the operator inaccessible to the front end, so that the work of teaching the robot is difficult to do according to the conventional method.

In order to solve the problem above, there has been is proposed a method as in JP-A-08-071973 (Japanese Application Publication Number; Hei08-071973), including the steps of fitting a range sensor and a camera to the hand portion of a robot and providing a mark on a working stage side whereby to teach a robot position while watching not only range information from the range sensor but also the mark within the image picked up by the camera.

According to the method proposed in JP-A-08-071973, however, two kinds of equipment such as the range sensor and the camera are needed in the respective vertical and horizontal directions, which results in developing a problem of costing money.

As these kinds of equipment are fitted to the front end of the robot and caused to move together with the robot, trouble is likely to occur with signal lines hanging around the robot.

Since these kinds of equipment are unnecessary except when teaching is done, they ought to be detachable but the problem is that wear-out powder produced when the equipment is removed may lower cleanness inside the front end.

### SUMMARY OF THE INVENTION

### DISCLOSURE OF THE INVENTION

It is therefore an object of the invention to provide a method for teaching a wafer carrying robot which employs a simple, inexpensive apparatus and is capable of not only maintaining a clean condition inside a front end but also effecting a saving of teaching work.

In order to solve the foregoing problem, a method for teaching a wafer carrying robot to carry a wafer placed and held in a predetermined place out of the place or to carry a wafer in a predetermined place comprises the steps of: providing a positioning mark on the hand of the wafer carrying robot, arranging a teaching plate at a predetermined place, the teaching plate having a camera for pickup of the positioning mark, making the camera take a photograph of the positioning mark, correcting the position of the hand by an operator's operation so that the positioning mark occupies a predetermined position in the image picked up by the camera, and positioning the hand in a horizontal plane.

Further, the position of the hand in its height direction is adjusted by the operator to bring the image of the positioning mark picked up by the camera into focus and then the positioning of the hand in its vertical direction is carried out with the height in focus as a reference. Moreover, the difference between the position of the positioning mark in the image of the positioning mark photographed by the camera and the position of the positioning mark in the image obtained when the hand is properly positioned is measured. Then the position of the hand is automatically corrected by means of the difference measured to carry out the positioning of the hand in the horizontal plane.

While the hand is being moved in the vertical direction, the differential value of shading of pixels in the image of the positioning mark photographed by the camera is obtained and the hand is stopped in a position where the number of pixels whose differential value exceeds a predetermined threshold is maximized so as to carry out the positioning of the hand in the vertical direction with the then height of the hand as a reference.

Further, the size of the image of the positioning mark photographed by the camera is obtained and compared with a predetermined size and the hand is moved vertically so that the size of the image becomes equal to the predetermined size to carry out the positioning of the hand in the vertical direction.

The wafer carrying robot is taught by using the teaching plate having a transmitter for wirelessly transmitting a signal of the image photographed by the camera.

The teaching plate has such a configuration and dimensions as to be able to carry out the positioning of an actual wafer as well and a camera for pickup of a mark for use in positioning the hand of a wafer carrying robot.

The teaching plate has a transmitter for wirelessly transmitting a signal of the image photographed by the camera.

### BRIEF DESCRIPTION OF THE DRAWING

FIG. 1 is a perspective view of a wafer carrying apparatus according to the present invention.

FIG. 2 is a top plan view of a hand according to the present invention.

FIG. 3 is a top plan view of a teaching plate according to the present invention.

FIG. 4 is a flowchart according to the present invention.

FIG. 5 is an view for explanation illustrating the relation among an object, a lens and an image.

FIG. 6 is a view showing an image of a positioning mark before positioning is carried out.

FIG. 7 is a view showing an image of the positioning mark after positioning is carried out.

FIG. 8 is a perspective view of wafer carrying apparatus according to another embodiment of the present invention.

FIG. 9 is a flowchart according to another embodiment of the present invention.,

FIG. 10 is conceptual illustration of a front end.

### DESCRIPTION OF THE PREFERRED EMBODIMENT

A description will now be given of embodiments of the invention by reference to the drawings.

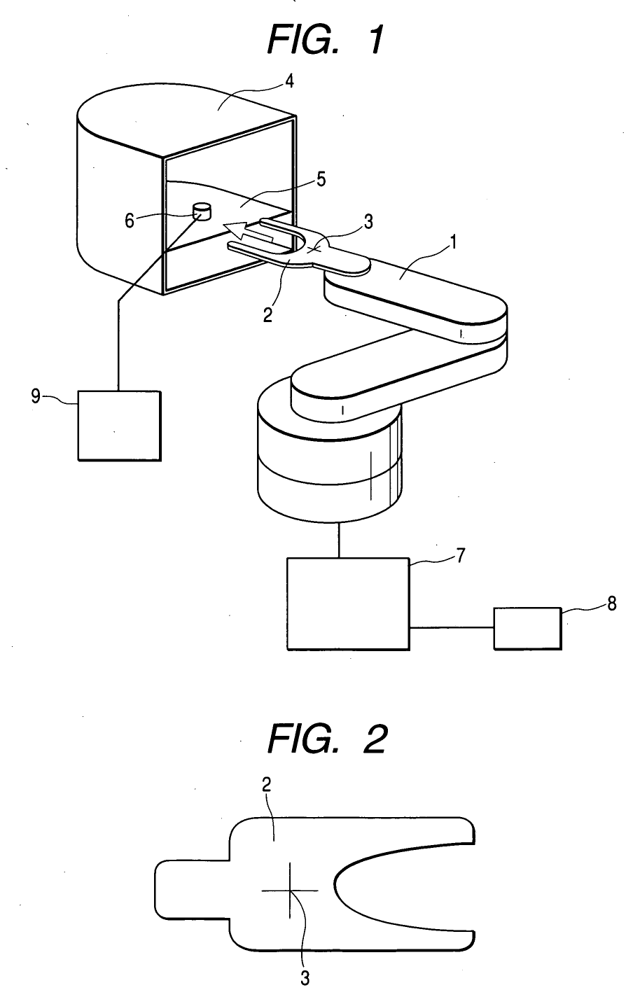

FIG. 1 is a perspective view of a wafer carrying apparatus embodying the present invention. In FIG. 1, reference numeral 1 denotes a wafer carrying robot and a hand 2 is attached to the front end of the wafer carrying robot and used for carrying and holding a wafer, a positioning mark 3 being affixed onto the hand 2. Reference numeral 4 denotes a wafer cassette for containing wafers. Reference numeral 5 denotes a teaching plate as a substitute for an actual wafer to be inserted into the wafer cassette. Reference numeral 6 denotes a camera adapted to take a photograph of the downward side of the teaching plate 5.

The wafer carrying robot 1 is controlled by a controller 7 and an operator uses an operating box 8 connected to the controller 7 for teaching the hand 2 to rotate on a vertical shaft and teaching the wafer cassette 4 to move back and forth and also vertically upward and downward. An image photographed by the camera 6 is fed into a TV monitor 9 and the operator is allowed to do teaching by moving the wafer carrying robot while confirming the image on the TV monitor 9.

FIG. 2 is a top plan view of the hand according to an embodiment of the invention. The hand 2 is a flat plate for carrying and holding the wafer and the positioning mark 3 is affixed to the top surface of the hand 2. Although the positioning mark 3 according to this embodiment of the invention is a cross-shaped mark, it may be any mark as long as it has a configuration that can specify the position and direction of the hand 2. Moreover, such a mark may be affixed to not only the top surface of but also both sides of the hand 2, depending on the condition of use.

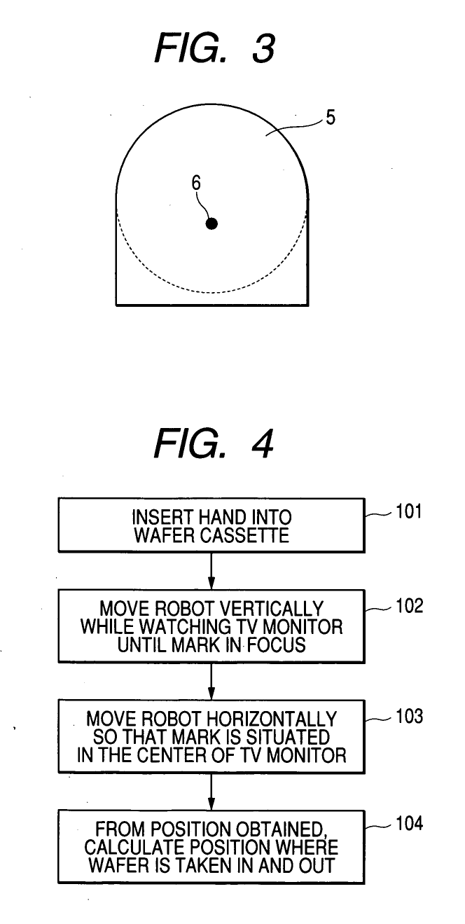

FIG. 3 is a top plan view of the teaching plate according to the embodiment of the invention. The teaching plate 5 has a semicircular portion having about the same diameter as that of an actual wafer so that when the teaching plate 5 is inserted into the wafer cassette 4 in place of the actual wafer so as to teach the wafer carrying robot 1, the positioning of the teaching plate 5 can be carried out like the actual wafer. A dotted line indicates the configuration of the actual wafer. Reference numeral 6 denotes the camera fitted to the teaching plate 5. The camera 6 is preferably as small as possible. The camera 6 is arranged so as to have the positioning mark 3 taken at the center of the TV monitor 9 when the hand 2 is properly positioned on the teaching plate 5.

FIG. 4 is a flowchart according to the embodiment of the invention.

The teaching plate 5 is properly positioned within the wafer cassette 4 before the flowchart is executed. Thy wafer cassette 4 has 25 slots arranged vertically with an equal pitch in order to carry 25 sheets of wafers and it is prearranged which one of the 25 slots in tiers is to receive the teaching plate 5.

At Step 101, the robot 1 is moved horizontally first and the hand 2 is inserted under the teaching plate 5 within the wafer cassette 4. In this case, an off-line simulator or the like is used to calculate the horizontal position beforehand.

At Step 102, the operating box 8 is used to move the robot 1 vertically and make the hand 2 approach the teaching plate 5. At this time, the operator is monitoring the image photographed by the camera 6 on the TV monitor 9 and stops the vertical movement of the robot 1 at a point of time the positioning mark 3 is brought into focus.

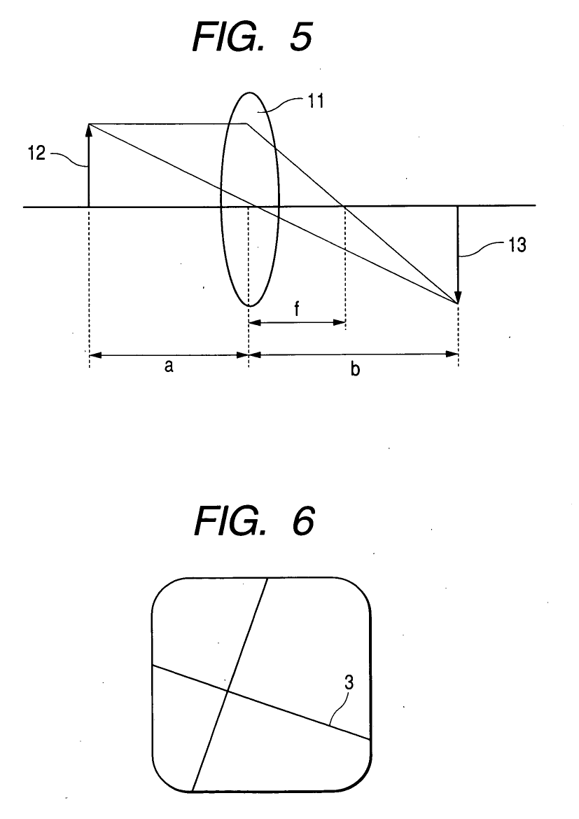

When a lens 11 having a focal length of f is used to bring an image 13 of an object 12 into focus on an imaging device (not shown) as shown in FIG. 5, there is the following relation between the distance a from the lens 11 up to the object 12 and the distance b from the lens 11 up to the image 13.

l f=l/a+l /b (Eq. 1)

In other words, the condition established by Eq. 1 is an in-focus condition. According to this embodiment of the invention, the focal length f of the lens 11 of the camera 6 is fixed and the distance from the lens 11 up to the imaging device is also fixed, whereupon the distance a from the lens 11 in focus up to the object 12 is determined uniquely. Therefore, the position in the vertical direction of the hand 2 with respect to the teaching plate 5 can simultaneously be identified constantly at all times in the operation of Step 102.

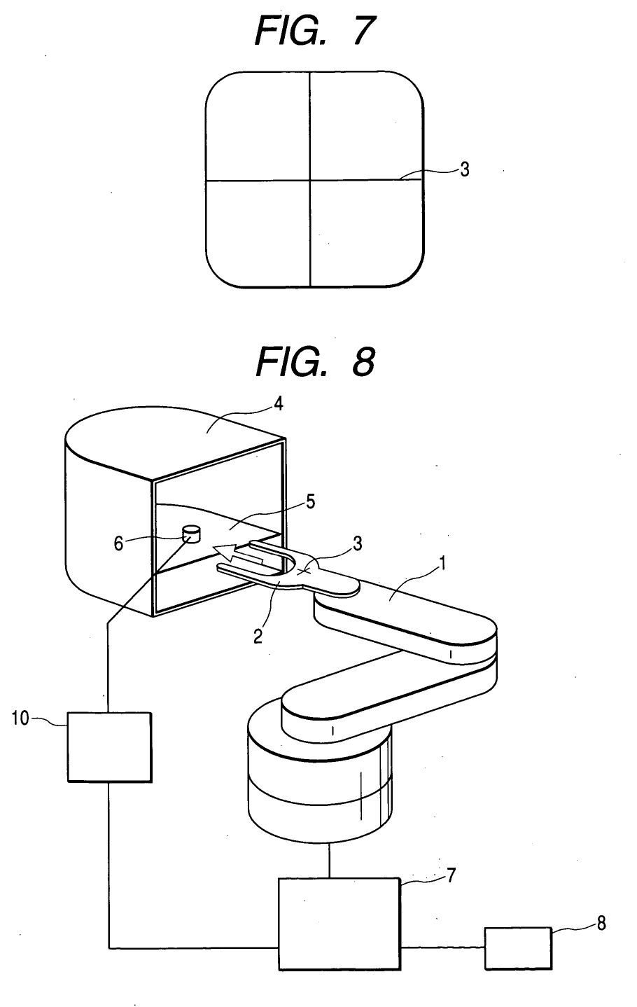

At Step 103, further, the position in the horizontal direction is adjusted. FIG. 6 shows an example of the image of the positioning mark 3 photographed by the camera 6 at a point of time Step 102 is terminated in such a condition that the position of the positioning mark 3 deviates from the predetermined one. While watching the screen of the TV monitor 9, the operator adjusts the horizontal position and direction of the hand 2 using the operating box 8 from the rotational motion around the vertical shaft of the robot 1 as well as the back-and-forth movements of the hand 2 with respect to the wafer cassette 4, so that the position of the positioning mark 3 is situated in the center of the screen as shown in FIG. 7.

With the operation performed until now, the position and direction of the hand 2 with respect to the teaching plate 5 positioned in a certain slot are determined uniquely. Consequently, at Step 104, each teaching point of the robot 1 for another slots (: the slots in which the teaching plate 5 is not placed) is obtained by the calculation based on the position of the hand 2 in this state. In other words, position data on any other slot is prepared by shifting the position data used for teaching given to a certain slot in the height direction.

Thus the teaching point of the robot 1 can be determined when the wafer is taken in and out of the wafer cassette 4.

FIG. 8 is a perspective view according to another embodiment of the invention. Although the constitution according to this embodiment of the invention is basically similar to what is shown in FIG. 1, the difference lies in the fact that the image photographed by the camera 6 is analyzed by an image processing unit 10 and the analyzed results are fed into the controller 7.

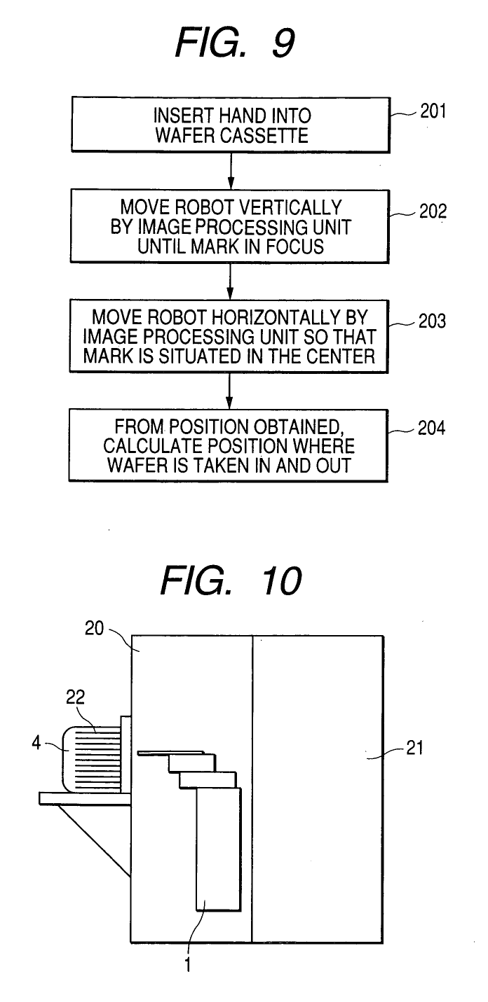

FIG. 9 is a flowchart according to this another-embodiment of the invention.

At Step 201, a robot 1 is moved horizontally first and a hand 2 is inserted into a wafer cassette 4. In this case, an off-line simulator or the like is used to calculate the horizontal position beforehand.

At Step 202, the image processing unit 10 is used to assess the unsharp condition of an image and a vertical motion command based on the information acquired thereby is fed into a controller 7. The unsharp condition of the image can be made known by calculating the differential value of the whole picture and finding the size of the value.

The differential value mentioned above indicates ratio by which the brightness (a shading-value) of the image spatially changes and to put it concretely, it indicates the difference in a shading value between adjoining pixels.

When the image is subjected to the differential processing, the contour portion is extracted. In the case of an image in focus, the differential value grows larger as the contour portion becomes clear. Therefore, the image is said to be in focus when the number of pixels whose differential values are greater than a predetermined threshold is maximized. Then the vertical movement of the robot 1 is stopped at this point of time.

At Step 203, the deviation of the position of the mark 3 from a predetermined position is obtained by the image processing unit 10 and the rotation command and the back-and-forth movement command of the robot 1 based on the information acquired thereby are fed into the controller 7. A method of obtaining the position and direction of the mark 3 from the image photographed by the camera 6 can be selected from known image processing methods including binarizing the image with a proper threshold, calculating the center of gravity and so forth.

Finally, the movement of the robot 1 is stopped when the position of the positioning mark 3 is situated in the center of the screen as shown in FIG. 7.

Step 204 is a step in which a position data on any other slot is prepared by shifting the position data used for teaching given to a certain slot in the vertical direction.

The positioning of the hand 2 in the vertical direction may be prepared by a method in which a height of the hand 2 is adjusted automatically so that a size of the image of the positioning mark 3 photographed by the camera 6 becomes a predetermined size, instead of the aforementioned method using adjustment of the focus condition.

In particular, steps of following (1) to (3) may be used.

(1) Obtaining a size (for example, a number of pixels of a line in a width direction constituting the positioning mark 3) of the image of the positioning mark 3 when the hand 2 is positioned in a correct position relative to the wafer, by a calculation or an experimental test in advance.

(2) Then, obtaining a size of the image of the positioning mark 3 in an actual teaching by the image processing unit 10, and comparing the size in the actual teaching with a predetermined size obtained by the calculation in advance.

(3) If the size of the image of the positioning mark 3 is larger than the predetermined size, outputting a signal to move the hand 2 downward (to detach the hand 2 from the teaching plate 5) from the image processing unit 10 to the controller 7. If the size of the image of the positioning mark 3 is smaller than the predetermined size, outputting a signal to move the hand 2 upward.

FIG. 1 and FIG. 8 show an example of the case where the camera 6 is coupled to the TV monitor 9 or the image processing unit 10 with a cable; however, a wireless transmitter for transmitting a wireless signal as an image signal from the camera 6 is fitted to the teaching plate 5 whereby to connect the camera 6 to the TV monitor 9 or the image processing unit 10 by wireless.

Although a description has been given of the teaching method for carrying wafers within the processing unit 21 according to the above embodiments of the invention, the method according to the invention is not solely intended for teaching on carrying wafers out of the wafer cassette 4. It is needless to say applicable to teaching on carrying wafers out of the processing unit 21 to place the teaching plate 5 instead of the wafer on a stage within the processing unit 21.

Thus the following effect is achievable according to the invention as described above.

As teaching on the position of the robot can be done while the image photographed by the camera is being watched, the operator is not required to enter the front end. Since the camera is fitted to the teaching plate, it is only needed to put a mark on the robot side, which makes unnecessary the provision of measuring equipment at the front end of the robot, thus eliminating a primary factor of trouble. Further, as any step of attaching and detaching the equipment to and from the robot is not taken, a clean condition within the front end is maintainable.

As the adjustment of the teaching point in the vertical direction utilizes the focusing of the camera or the size of the image of the positioning mark, the range sensor can be dispensed with, so that the manufacturing costs become reducible.

In addition to the effect referred to above, the use of the image processing technique makes it realizable automatically adjusting the horizontal and vertical directions of the robot and effecting a substantial saving of teaching work.

### Industrial Applicability

The invention is useful as a method for teaching a wafer carrying robot, particularly a wafer carrying robot for carrying wafers held in a wafer cassette out of the wafer cassette and as a teaching plate for use in the method.

What is claimed is:

1. A method for teaching a wafer carrying robot to carry a wafer placed and held in a predetermined place out of the place or to carry a wafer in a predetermined place, comprising the steps of:
providing a positioning mark on the hand of the wafer carrying robot,
arranging a teaching plate at a predetermined place, the teaching plate having a camera for pickup of the positioning mark,
making the camera take a photograph of the positioning mark,
correcting the position of the hand by an operator's operation so that the positioning mark occupies a predetermined position in the image picked up by the camera, and
positioning the hand in a horizontal plane.

2. A method for teaching a wafer carrying robot according to claim 1,
wherein the position of the hand in its height direction is adjusted by the operator's operation to bring the image of the positioning mark picked up by the camera into focus, and
the positioning of the hand in its vertical direction is carried out based on the height adjusted so that the positioning mark is picked us into focus.

3. A method for teaching a wafer carrying robot to carry a wafer placed and held in a predetermined place out of the place or to carry a wafer in a predetermined place, comprising the steps of:
providing a positioning mark on the hand of the wafer carrying robot,
arranging a teaching plate at a predetermined place, the teaching plate having a camera for pickup of the positioning mark,
making the camera take a photograph of the positioning mark,
measuring the difference between the position of the positioning mark in the image of the positioning mark photographed by the camera and the position of the positioning mark in the image obtained when the hand is properly positioned,
automatically correcting the position of the hand using the difference measured, and
carrying out the positioning of the hand in the horizontal plane.

4. A method for teaching a wafer carrying robot according to claim 3,
wherein while the hand is being moved in the vertical direction, the differential value of shading of pixels in the image of the positioning mark photographed by the camera is obtained,
the hand is stopped in a position where the number of pixels whose differential value exceeds a predetermined threshold is maximized, and it
the positioning of the hand in its vertical direction is carried out based on the height where the hand is stopped.

5. A method for teaching a wafer carrying robot according to claim 3,
wherein the size of the image of the positioning mark photographed by the camera is obtained and compared with a predetermined size,
the hand is moved vertically so that the size of the image becomes equal to the predetermined size so as to carry out the positioning of the hand in the vertical direction.

6. A method for teaching a wafer carrying robot according to one of claim 1 through claim 5, wherein the wafer carrying robot is taught by using the teaching plate having a transmitter for wirelessly transmitting a signal of the image photographed by the camera.

7. A teaching plate, having:
a configuration and dimensions wherein the same positioning can be carried out with the actual wafer, and
a camera for pickup of a mark for positioning the hand of a wafer carrying robot.

8. A teaching plate according to claim 7, further having a transmitter for wirelessly transmitting a signal of the image, photographed by the camera.
